(19) United States
(12) Patent Application Publication
(10) Pub. No.: US 2009/0283294 A1
(43) Pub. Date: Nov. 19, 2009

(54) Cover Assembly for Cables and Electrical Connections and Methods for Using the Same

(76) Inventor: Rudolf Robert Bukovnik, Chapel Hill, NC (US)

Correspondence Address: Marguerite E. Gerstner;Tyco Electronics Corporation, M/S R34-2A, 309 Constitution Drive, Menlo Park, CA, 94025-1164, US

(21) Appl. No.: 12/122,048

(22) Filed: May 16, 2008

(51) Int. Cl. H01B 3/44; H01B 9/02

(52) U.S. Cl. 174/102 R; 174/110 R

(57) ABSTRACT

A cover assembly for covering an electrical substrate includes a double-walled, tubular sleeve defining an interior cavity between the walls thereof. The sleeve further defines a passage to receive the substrate. An uncured thermosetting polymer is disposed in the interior cavity. The sleeve can be installed on the substrate and the uncured thermosetting polymer cured thereon into a hardened resin to form a rigid cover assembly on the substrate, the rigid cover assembly including the sleeve and the hardened resin.

### FIELD OF THE INVENTION

The present invention relates to electrical cables and connections and, more particularly, to covers for cables and electrical connections.

### BACKGROUND OF THE INVENTION

Covers are commonly employed to protect or shield electrical power cables and connections (e.g., low voltage cables up to about 1000 and medium voltage cables up to about 65 kV). One application for such covers is for splice connections of paper insulated lead cable (PILC). A PILC typically includes at least one conductor surrounded by an oil impregnated paper insulation layer, and a lead sheath surrounding the conductor and insulation layer. In some cases, it is necessary to contain the oil. It is known to use a heat shrinkable sleeve made of a polymer that does not swell when exposed to the oil. Examples of such heat shrinkable sleeves include heat shrinkable oil barrier tubes (OBT) available from Tyco Electronics Corporation of Fuquay-Varina, N.C. The sleeve is placed over the oil impregnated paper and heat is applied to contract the sleeve about the insulation layer. Mastic or other sealant material may be used at each end of the sleeve to ensure an adequate seal and containment of the oil.

### SUMMARY OF THE INVENTION

According to embodiments of the present invention, a cover assembly for covering an electrical substrate includes a double-walled, tubular sleeve defining an interior cavity between the walls thereof. The sleeve further defines a passage to receive the substrate. An uncured thermosetting polymer is disposed in the interior cavity. The sleeve can be installed on the substrate and the uncured thermosetting polymer cured thereon into a hardened resin to form a rigid cover assembly on the substrate, the rigid cover assembly including the sleeve and the hardened resin.

According to some embodiments, the passage is an axial passage and the sleeve is axially revolvable.

According to some embodiments, the sleeve is radially elastically expandable. The sleeve may be formed of an elastomeric material. In some embodiments, the sleeve is formed of EPDM, neoprene, TPV, TPE or polyurethane.

According to some embodiments, the uncured thermosetting polymer includes an uncured thermosetting epoxide polymer, the cover assembly further includes a catalyzing agent disposed in the interior cavity, and the uncured thermosetting epoxide polymer and the catalyzing agent are temporarily separated from one another in the interior cavity such that they can be selectively mixed with one another in the interior cavity to form the hardened resin in the interior cavity. The uncured thermosetting epoxide polymer and the catalyzing agent may be temporarily separated from one another in the interior cavity by a clamp.

According to some embodiments, the sleeve is mounted on a holdout in an elastically radially expanded state.

According to method to embodiments of the present invention, a method for using a cover assembly to cover an electrical substrate includes providing a cover assembly including: a double-walled, tubular sleeve defining an interior cavity between the walls thereof, the sleeve further defining a passage to receive the substrate; and an uncured thermosetting polymer disposed in the interior cavity. The method further includes: installing the sleeve on the substrate; and curing the uncured thermosetting polymer on the substrate into a hardened resin to form a rigid cover assembly on the substrate, the rigid cover assembly including the sleeve and the hardened resin.

According to some embodiments, the passage is an axial passage and the method includes axially revolving the sleeve along the axial passage.

The method may include: radially elastically expanding the sleeve to install the sleeve on the substrate; and permitting the sleeve to radially elastically contract onto the substrate to effect a seal with the substrate. According to some embodiments, the sleeve is mounted on a holdout in an elastically radially expanded state, and the method includes rolling the sleeve from the holdout onto the substrate.

According to some embodiments, the uncured thermosetting polymer includes an uncured thermosetting epoxide polymer, the cover assembly further includes a catalyzing agent disposed in the interior cavity, the uncured thermosetting epoxide polymer and the catalyzing agent are temporarily separated from one another in the interior cavity, and the method further includes selectively mixing the uncured thermosetting epoxide polymer and the catalyzing agent with one another in the interior cavity to form the hardened resin in the interior cavity. The method may further include releasing a clamp on the sleeve to permit the uncured thermosetting epoxide polymer and the catalyzing agent to be mixed with one another in the interior cavity.

According to some embodiments, the substrate includes a power transmission cable. In some embodiments, the substrate includes a paper insulated lead cable (PILC) including an electrical conductor, an oil impregnated paper insulation layer surrounding the electrical conductor, and an lead sheath surrounding the oil impregnated paper insulation layer, and the method includes installing the cover assembly on the PILC such that the cover assembly contains the oil of the oil impregnated paper insulation layer. In some embodiments, the substrate further includes a second power transmission cable and a connector electrically and mechanically connecting the first and second power transmission cables, and the method includes installing the cover assembly on the first and second power transmission cables such that the cover assembly surrounds the connector.

According to embodiments of the present invention, a covered electrical assembly includes an electrical substrate and a cover assembly covering the electrical substrate. The cover assembly includes a double-walled, tubular sleeve defining an interior cavity between the walls thereof, the sleeve further defining a passage receiving the substrate, and an uncured thermosetting polymer disposed in the interior cavity. With the sleeve installed on the substrate, the uncured thermosetting polymer can be cured into a hardened resin to form a rigid cover assembly on the substrate, the rigid cover assembly including the sleeve and the hardened resin.

According to some embodiments, the substrate includes a paper insulated lead cable (PILC) including an electrical conductor, an oil impregnated paper insulation layer surrounding the electrical conductor, and an lead sheath surrounding the oil impregnated paper insulation layer, and the cover assembly is mounted on the PILC such that the cover assembly contains the oil of the oil impregnated paper insulation layer. In some embodiments, the covered electrical assembly includes: a second electrical conductor and a second oil impregnated paper insulation layer surrounding the second electrical conductor; a third electrical conductor and a third oil impregnated paper insulation layer surrounding the third electrical conductor; a second cover assembly mounted on the PILC such that the second cover assembly contains the oil of the second oil impregnated paper insulation layer; and a third cover assembly mounted on the PILC such that the third cover assembly contains the oil of the third oil impregnated paper insulation layer.

Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1 is a perspective view of a pre-expanded unit including a cover assembly and a holdout device according to some embodiments of the present invention.

FIG. 2 is a cross-sectional view of the pre-expanded unit of FIG. 1 taken along the line 2-2 of FIG. 1.

FIG. 3 is a cross-sectional view of the pre-expanded unit of FIG. 1 taken along the line 3-3 of FIG. 2.

FIG. 4 is a cross-sectional view of the pre-expanded unit of FIG. 1 taken along the line 2-2 of FIG. 1, but wherein a separator clamp thereof has been removed.

FIG. 5 is a side view of the pre-expanded unit of FIG. 1 positioned for subsequent installation on a first cable.

FIG. 6 is a side elevational view of the cover assembly of FIG. 1 mounted on the first cable of FIG. 5, and a second cable connected to the first cable by a splice connector.

FIG. 7 is a partial cross-sectional view of the cover assembly of FIG. 1 mounted on the first and second cables and over the connector of FIG. 6.

FIG. 8 is a partial cross-sectional view of the cover assembly of FIG. 1 mounted on a cable and covering a hole in an outer insulation jacket of the cable.

FIG. 9 is a side view of a PILC.

FIG. 10 is a side view of the PILC of FIG. 9 with sealant material applied thereto.

FIG. 11 is a side view of the PILC and sealant material of FIG. 9 with the cover assembly of FIG. 1 mounted thereon.

FIG. 12 is a side view of the assembly of FIG. 11 further including a polymeric cable spliced to the PILC by a splice connector and a transition joint cover.

FIG. 13 is a side view of a three-phase PILC.

FIG. 14 is a side view of the PILC of FIG. 13 including a cover assembly as illustrated in FIG. 1 mounted on each insulated conductor of the PILC.

FIG. 15 is a side view of the PILC of FIG. 14 spliced to a polymeric cable.

### DETAILED DESCRIPTION OF EMBODIMENTS OF THE INVENTION

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Like numbers refer to like elements throughout. As used herein the term “and/or” includes any and all combinations of one or more of the associated listed items.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

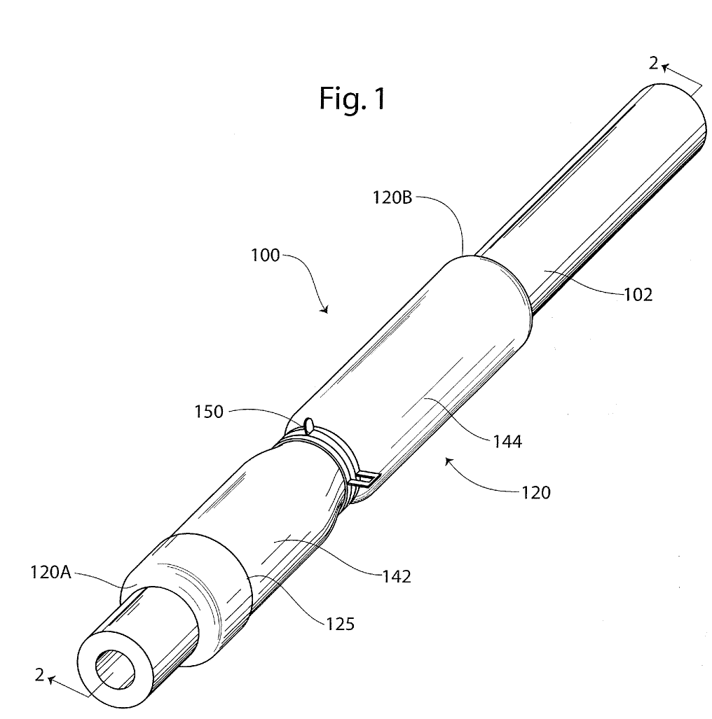

With reference to FIGS. 1-4, a cover assembly 100 according to some embodiments of the present invention is shown therein. The cover assembly 100 includes a sleeve 120, a thermosetting polymer 112, a catalyzing agent 114, and a separator clamp 150, as discussed in more detail below. The cover assembly 100 may be used to cover (and, in some embodiments, electrically insulate) electrical substrates such as cables and connectors. The cover assembly 100 may be provided as a pre-expanded unit 101 including a holdout device 102, as shown in FIGS. 1-3, wherein the cover assembly 100 is in an expanded state or position. The cover assembly 100 may be deployed and mounted on the intended substrate in a retracted state or position as shown in FIGS. 7, 8, 11 and 14 and discussed in more detail below. According to some embodiments, the cover assembly 100 is a cold shrink cover, meaning that it can be shrunk or retracted about the substrate without requiring the use of applied heat. Once the cover 100 has been installed on the substrate, the thermosetting polymer 112 and the catalyzing agent 114 can be mixed and cured to form a hardened resin within the sleeve 120 and about the substrate.

Referring to FIGS. 1-3, the sleeve 120 is a tubular, integral, double-walled sleeve of a unitary or single piece construction. The sleeve 120 extends from a first end 120A to a second end 120B. The sleeve 120 has an inner wall 122 and an outer wall 124 joined at the ends 120A, 120B. As will be appreciated from the description herein and the drawings, the walls of the sleeve 120 form an endless, continuous band (closed by an annular seam 125) that is axially revolvable about itself so that the portions thereof that constitute the inner wall 122 and the outer wall 124 at any given time may vary depending on the position of the sleeve 120. Likewise, the portions of the sleeve 120 positioned at the ends 120A, 120B will change as the sleeve 120 is revolved or rolled. That is, when the sleeve 120 is revolved along its axis, the sleeve 120 will evaginate (i.e., turn inside-out by eversion of the inner wall) at one end and invaginate (i.e., turn outside-in by inversion of the outer wall) at the other (opposite) end. An annular or tubular cavity 130 is defined between the inner wall 122 and the outer wall 124.

The sleeve 120 has a central lengthwise axis A-A. The inner wall 122 defines an axially extending through passage 126 that communicates with opposed end openings 126A, 126B.

The clamp 150 surrounds and compresses a midsection of the sleeve 122 so that the sleeve 120 is thereby divided into two sleeve sections 142, 144 separated by a barrier section 146. The clamp 150 thereby also divides the cavity 130 into a subcavity 132 (within the sleeve section 142) and a subcavity 134 (within the sleeve section 144). The thermosetting polymer 112 is contained and sealed within the subcavity 132 between the end 120A and the barrier section 146. The catalyzing agent 114 is contained and sealed within the subcavity 134 between the end 120B and the barrier section 146.

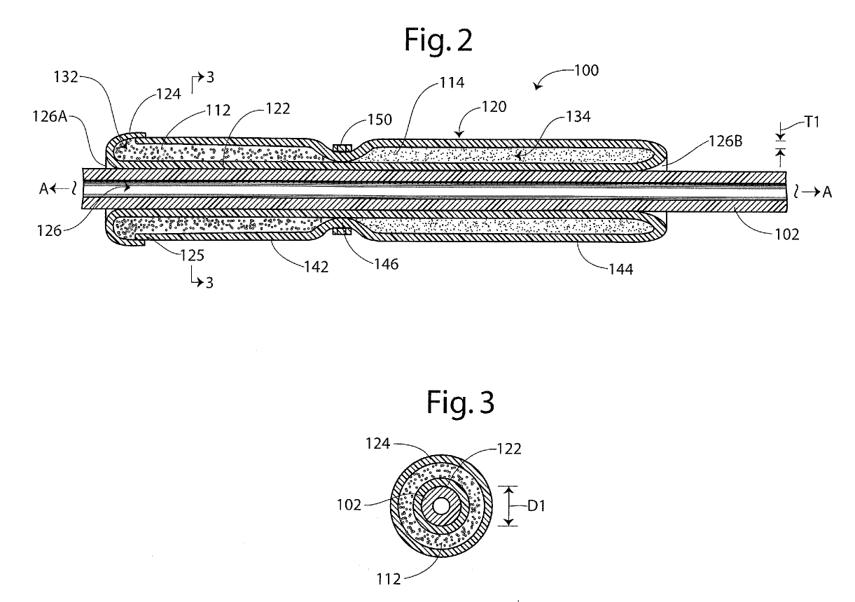

The sleeve 120 can be formed of any suitable material. According to some embodiments, the sleeve 120 is formed of an electrically insulative material. According to some embodiments, the sleeve 120 is formed of an elastically expandable material. According to some embodiments, the sleeve 120 is formed of an elastomeric material. According to some embodiments, the sleeve 120 is formed of at least one of EPDM, neoprene, butyl or polyurethane. Other suitable materials may include thermoplastic vulcanizate (TPV) or thermoplastic elastomer (TPE). According to some embodiments, the sleeve 120 has an elastic modulus of no greater than about 2000 psi. According to some embodiments, the thickness T1 (FIG. 2) of the sleeve 120 is in the range from about 0.030 to 0.120 inch.

The thermosetting polymer 112 and the catalyzing agent 114 may be any suitable materials. According to some embodiments, the thermosetting polymer 112 is an epoxy (polyepoxide) that cures (polymerizes and crosslinks) when mixed with the catalyzing agent 114 (i.e., the catalyzing agent 114 serves as a “hardener”). Suitable materials for the thermosetting polymer 112 include Bisphenol A type epoxy, epoxy novolac or polyglycol epoxy and polyester resin. Suitable materials for the catalyzing agent 114 include amines, anhydrides or dicyandiamide.

The separator clamp 150 may be formed of any suitable material and of any suitable configuration. For sample, the separator clamp 150 can take the form of a spring hose clamp as illustrated. The separator clamp 150 is constructed to maintain a secure seal about the barrier section 146 while nonetheless being removable by an operator when desired. According to some embodiments, the separator clamp 150 is removable by hand.

The holdout 102 can be formed of any suitable material. According to some embodiments, the holdout 102 is formed of a rigid cardboard or plastic. The holdout device 102 may be factory installed. In some embodiments, the cover assembly 100 may instead be pre-expanded in the field using a suitable expansion tool.

Referring now to FIGS. 5-7, the unit 101 may be used in the following manner to apply the cover 100 over a splice connection 10 (FIG. 7) between a pair of an electrical power transmission cables 40. According to some embodiments, the cables 40 are low-voltage (e.g., between about 5 volts and 5 kV) power transmission cables. Each cable 40 includes an electrical conductor 42 and a surrounding insulation jacket 44.

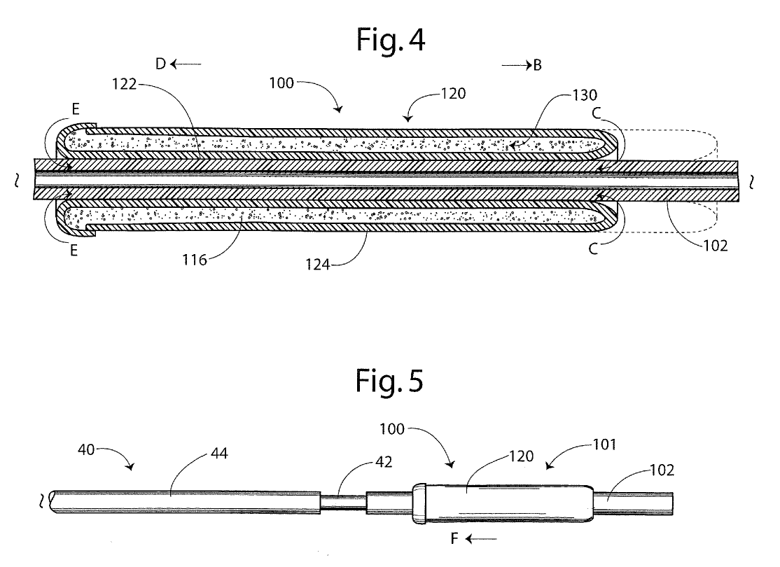

Initially and in preparation for installing the cover assembly 100, the operator removes the clamp 150 as shown in FIG. 4. In this manner, the subcavities 132, 134 are placed in fluid communication with one another. Additionally, the sleeve 120 is freed to roll or revolve up and down the length of the holdout 102. More particularly, the sleeve 120 can be pushed or pulled in a direction B to a position more proximate the right end of the holdout 102 as shown in dashed lines, for example. Such movement of the sleeve 120 will cause the sleeve portion forming the outer wall 124 to rotate inwardly in a direction C to become the inner wall 122 and will likewise cause the sleeve portion forming the inner wall 122 to rotate outwardly to become the outer wall 124. Similarly, the sleeve 120 can be pushed or pulled in an opposite direction D, thereby causing the sleeve portion forming the outer wall 124 to rotate inwardly in a direction E to become the inner wall 122 and likewise cause the sleeve portion forming the inner wall 122 to rotate outwardly to become the outer wall 124. According to some embodiments, the operator rolls the sleeve 120 back and forth in the directions B and D on the holdout 102 to substantially mix the thermosetting polymer 112 and the catalyzing agent 114 into a mixture 116 (FIG. 4). Additionally or alternatively, the components 112, 114 can be mixed by rolling the sleeve 120 back and forth on the cable 40.

In its expanded state, the sleeve 120 is radially expanded (relative to the axis A-A) such that its inner diameter D1 (FIG. 3) is sufficient to receive the stripped cable 40 and the connector 30 without undue effort. According to some embodiments, the expanded inner diameter D1 is at least as great as the outer diameter of the largest portion of the cable 10 that is to be received in the passage 126.

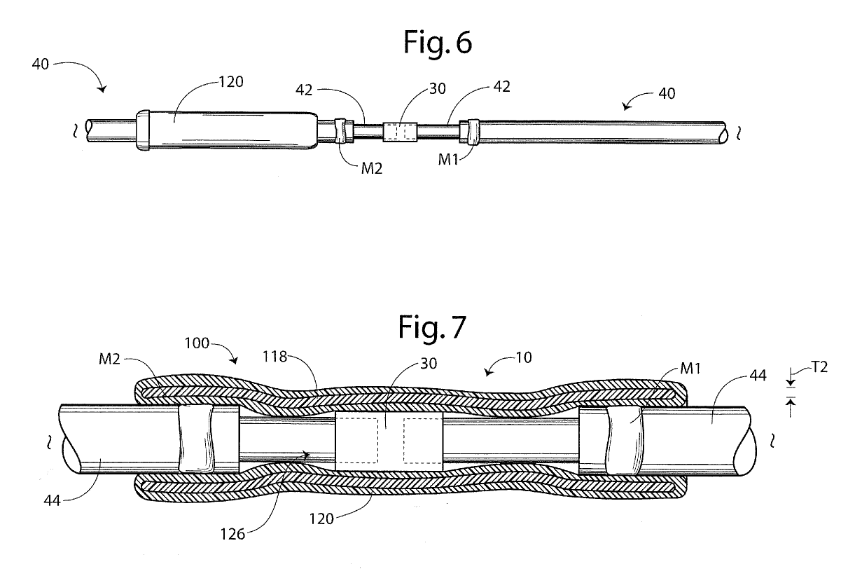

With reference to FIG. 5, the unit 101 is positioned adjacent the end of the conductor 42 of one of the cables 40 such that the holdout 102 abuts the end of the conductor 42 as shown. The sleeve 120 is then rolled in a direction F off of the holdout 102 and onto the cable 40. The sleeve 120 may be parked on the cable 40 a short distance from the terminal end of the insulation 44 as shown in FIG. 6.

Optionally, a sealing compound M1, M2 (e.g., mastic) may be applied about the insulation layers 44 of each cable 40. The sealing compound M1, M2 may be adapted to provide both electrical stress relief and an oil-proof seal. The conductors 42 of the cables 40 are electrically and mechanically coupled by a connector 30 as shown in FIG. 6.

The sleeve 120 is then rolled over the connector 30 as shown in FIG. 7 to span the splice connection between the cables 40 and also to overlap the sealing compound strips M1, M2 and the respective insulation layers 44 of the cables 40. FIG. 7 is an enlarged view as compared to FIGS. 5 and 6 and the cover assembly 100 is shown in cross-section.

The relaxed inner diameter of the sleeve 120 is less than at least the outer diameter of the insulation layers 44. Therefore, the sleeve 120 exerts a radially inwardly compressive or clamping force or pressure (due to elastic tension) onto the cables 40. The sleeve 120 thereby effects a liquid tight seal at the interface between the cable insulation 44 and the sleeve 120. This seal can protect the cable and the splice from the ingress of environmental moisture. According to some embodiment, the relaxed inner diameter of the sleeve 120 is at least 10% less than the smallest diameter cable 40 upon which the sleeve 120 is intended to be installed.

From the time of releasing the clamp 150 until the installation of the sleeve 120 on the cables 40 and expanding the splice connection therebetween as shown in FIG. 7, the thermosetting polymer mixture 116 is in a liquid or viscous state. As such, the mixture 116 permits the sleeve 120 to be deformed, expanded, contracted and rolled to permit proper cold shrink installation and sealing of the sleeve 120 about the connection 10. However, over time the mixture 116 cures and hardens into a hardened resin 118 within the cavity 130. The hardening of the thermosetting polymer mixture 116 into the rigid stricture or shell of the hardened resin 118 thus transforms the cover assembly 100 into a rigid cover assembly including the sleeve 120 and the hardened resin 118. According to some embodiments, the mixture 116 has a working time (during which the mixture 116 is still viscous enough to permit rolling of the sleeve 120) of at least about 5 minutes and, according to some embodiments, between about 10 and 120 minutes. Advantageously, the mixture 116 can serve as a lubricant to facilitate rolling of the sleeve 120 during installation.

According to some embodiments, the hardened resin 118 has a nominal thickness T2 (FIG. 7) of at least about 50 cps. According to some embodiments, the thickness T2 is in the range of from about 100 to 100,000 cps.

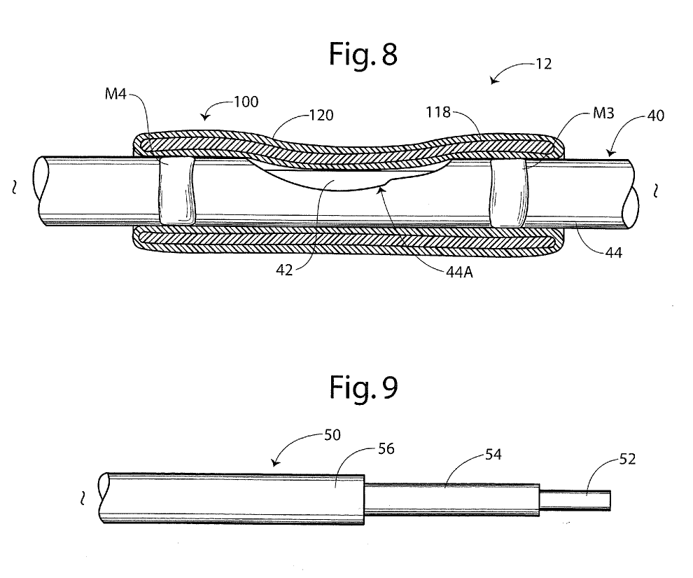

With reference FIG. 8, an alternative application of the cover assembly 100 is shown therein. In FIG. 8, the cover assembly 100 is shown installed on a single cable 40 such that the sleeve 120 spans and forms a seal about either side of an opening 44A in the insulation jacket 44 of the cable 40. The sleeve sealing may be augmented by strips of sealing compound M3, M4. The cover assembly 100 may be installed in substantially the same manner as discussed above with regard to FIGS. 5-7.

With reference to FIGS. 9-12, the cover assembly 100 is shown therein installed on a paper insulated lead cable (PILC) 50 and incorporated into a connection 14 between the PILC 50 and a polymeric cable 60. As shown in FIG. 9, the PILC 50 includes an electrical conductor 52, an oil impregnated paper insulation layer 54 surrounding the conductor 52, and a lead sheath 56 surrounding the insulation layer 54. The conductor 52 may be formed of any suitable conductor material such as copper, and may be a solid conductor or plurality of copper strands. The oil impregnating the layer 54 may be any suitable oil such as a mineral oil.

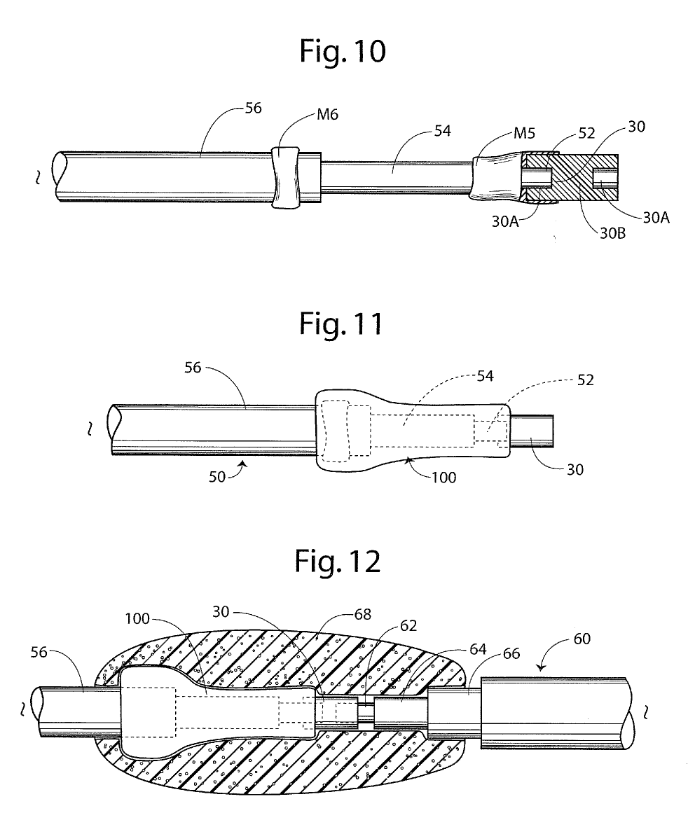

In order to form the connection 14, the PILC 50 is prepared as shown in FIG. 9. A connector 30 (shown in cross-section in FIG. 10) is secured to the conductor 52 as shown in FIG. 10. The connector 30 may be an oil stop connector defining enclosed cavities 30A to receive the respective conductors 52, 62 and having an oil stop or separator wall 30B therebetween. Optionally, sealing compound strips M5, M6 (e.g., mastic) may be applied about the lead sheath 56 and the end of the oil impregnated paper layer 54. According to some embodiments and as shown, the sealing compound strip M5 overlaps and extends continuously between each of the paper layer 54 and the connector 30 so that the exposed portion of the conductor 52 is fully circumferentially surrounded by the strip M5. The cover assembly 100 is then mounted on the end of the PILC 50 in the manner described above with reference to FIGS. 5-7. More particularly, the cover assembly 100 is positioned such that it overlaps the lead sheath 56 and the conductor 52, thereby fully spanning and surrounding the exposed portion of the oil impregnated paper layer 54. According to some embodiments and as shown, the cover assembly 100 further overlaps the connector 30. The cover assembly 100 thereby forms an oil-tight seal about each of the conductor 52 and the lead sheath 56 to prevent or inhibit the oil of the layer 54 (which may be under pressure) from leaking out of the cable 50.

The PILC 50 is then electrically and mechanically coupled to a conductor 62 of a polymeric cable 60 by the connector 30. The polymeric cable 60 further includes a polymeric insulation layer 64 and a semiconductor layer 66. A transition joint 68 may be installed over the splice connection 14 such that the joint 68 engages the lead sheath 56 and the semiconductor layer 66. According to some embodiments, the joint 68 is formed of an electrically conductive elastomer and electrically connects the lead sheath 56 and the semiconductor layer 66.

The cover assembly 100 may provide a number of advantages when installed on a PILC as described herein. In use, the cover assembly 100 may be subjected to high oil pressures as the oil from the oil impregnated paper insulation drains to lower cable elevation or fluctuates with temperature variations, for example. If the sleeve 120 were made of a relatively soft elastomeric material without provision of the hardened resin 118, these pressures would tend to expand or “blow-up” the sleeve 120 like a balloon, which may jeopardize the oil barrier seal. This effect may be exacerbated by the interaction between the elastomer of the sleeve 120 and the oil because soft rubbers, for example, tend to swell when exposed to oil for an extended period of time. In the case of the present invention, the hardened resin (e.g., the hardened resin 118) mechanically supports or reinforces the sleeve 120 so that the sleeve 120 can withstand the oil pressure without unduly expanding. According to some embodiments, the installed and cured cover assembly 100 can withstand an oil pressure up to at least about 50 psi.

The hardened resin 118 also permits the use of a softer elastomer for the sleeve 120. The use of a softer elastomer in turn enables a greater range taking for the cover assembly. That is, the softer rubber allows a greater range of radial expansion so that a given cover assembly 100 can be effectively installed on a greater range of cable diameters.

The hardened resin 118 may provide a number of additional advantages. The hardened resin 118 may provide the cover assembly 100 with greater toughness, puncture resistance, abrasion resistance and/or crush resistance. The hardened resin 118 may constitute an armor sheath to protect the underlying cable or connection. More generally, the hardened resin 118 may serve to maintain the integrity of the splice and the liquid-proof seal between the sleeve 120 and the cable. According to some embodiments, the hardened resin has a flexural strength of at least about 5000 psi and, according to some embodiments, at least about 12,000 psi.

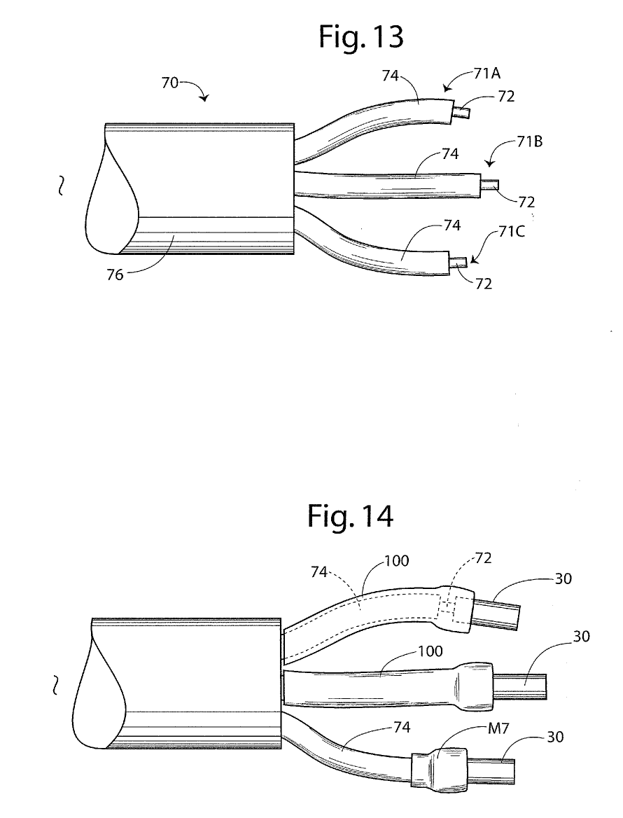

With reference to FIGS. 12-15, a plurality of cover assemblies 100 are shown therein installed on a multi-conductor (as shown, three phase) PILC 70 and incorporated into a connection 16 between the PILC 70 and three polymeric cables 60. As shown in FIG. 13, the PILC 70 includes three electrical conductors 72, a respective oil impregnated paper insulation layer 74 surrounding each conductor 72 (to form respective insulated conductors 71A, 71B, 71C), and a lead sheath 56 surrounding all three of the insulated conductors 71A, 71B, 71C.

A respective cover assembly 100, oil stop connector 70 and sealing compound M7 (e.g., electrical stress relieving compound) are mounted on each insulated conductor 71A, 71B, 71C in the same manner as described above with respect to the PILC 50, except that the inboard end of each cover assembly 100 does not overlap the lead sheath 76. In FIG. 14, the insulated conductor assembly 71C is shown with the connector 30 and the sealing compound M7 installed, but with the cover assembly 100 not yet mounted.

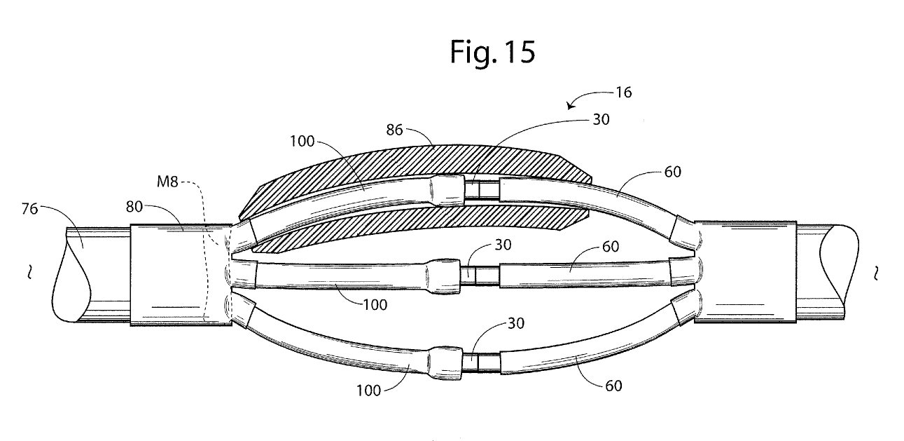

Thereafter and with reference to FIG. 15, sealing compound M8 may be applied about the end of the lead sheath 76 and between the insulated conductors 71A, 71B, 71C and a breakout boot 80 installed over the cover assemblies 100. The conductors 72 may be connected to the conductors of the polymeric cables 60 by means of the oil stop connectors 30, for example. Transition joints 86 (only one shown in FIG. 15) may be installed over each of the splice connections.

Cover assemblies according to embodiments of the invention may be used for any suitable cables and connections. Such cable assemblies may be adapted for use, for example, with connections of low voltage cables up to about 1000 V and medium voltage cables up to about 65 kV.

While the connections to PILCs have been described herein with reference to PILC-to-polymeric cable transition splices, cover assemblies as disclosed herein may also be used in PILC-to-PILC splices.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention. Therefore, it is to be understood that the foregoing is illustrative of the present invention and is not to be construed as limited to the specific embodiments disclosed, and that modifications to the disclosed embodiments, as well as other embodiments, are intended to be included within the scope of the invention.

That which is claimed is:

1. A cover assembly for covering an electrical substrate, the cover assembly comprising:
a double-walled, tubular sleeve defining an interior cavity between the walls thereof, the sleeve further defining a passage to receive the substrate; and
an uncured thermosetting polymer disposed in the interior cavity;
wherein the sleeve can be installed on the substrate and the uncured thermosetting polymer cured thereon into a hardened resin to form a rigid cover assembly on the substrate, the rigid cover assembly including the sleeve and the hardened resin.

2. The cover assembly of claim 1 wherein the passage is an axial passage and the sleeve is axially revolvable.

3. The cover assembly of claim 1 wherein the sleeve is radially elastically expandable.

4. The cover assembly of claim 3 wherein the sleeve is formed of an elastomeric material.

5. The cover assembly of claim 4 wherein the sleeve is formed of EPDM, neoprene, TPV, TPE or polyurethane.

6. The cover assembly of claim 1 wherein:
the uncured thermosetting polymer includes an uncured thermosetting epoxide polymer;
the cover assembly further includes a catalyzing agent disposed in the interior cavity; and
the uncured thermosetting epoxide polymer and the catalyzing agent are temporarily separated from one another in the interior cavity such that they can be selectively mixed with one another in the interior cavity to form the hardened resin in the interior cavity.

7. The cover assembly of claim 6 wherein the uncured thermosetting epoxide polymer and the catalyzing agent are temporarily separated from one another in the interior cavity by a clamp.

8. The cover assembly of claim 1 wherein the sleeve is mounted on a holdout in an elastically radially expanded state.

9. The cover assembly of claim 1 wherein:
the passage is an axial passage and the sleeve is axially revolvable;
the sleeve is radially elastically expandable;
the sleeve is formed of an elastomeric material;
the uncured thermosetting polymer includes an uncured thermosetting epoxide polymer;
the cover assembly further includes a catalyzing agent disposed in the interior cavity; and
the uncured thermosetting epoxide polymer and the catalyzing agent are temporarily separated from one another in the interior cavity such that they can be selectively mixed with one another in the interior cavity to form the hardened resin in the interior cavity.

10. A method for using a cover assembly to cover an electrical substrate, the method comprising:
providing a cover assembly including:
a double-walled, tubular sleeve defining an interior cavity between the walls thereof, the sleeve further defining a passage to receive the substrate; and
an uncured thermosetting polymer disposed in the interior cavity;
installing the sleeve on the substrate; and
curing the uncured thermosetting polymer on the substrate into a hardened resin to form a rigid cover assembly on the substrate, the rigid cover assembly including the sleeve and the hardened resin.

11. The method of claim 10 wherein the passage is an axial passage and including axially revolving the sleeve along the axial passage.

12. The method of claim 10 including:
radially elastically expanding the sleeve to install the sleeve on the substrate; and
permitting the sleeve to radially elastically contract onto the substrate to effect a seal with the substrate.

13. The method of claim 12 wherein the sleeve is mounted on a holdout in an elastically radially expanded state, and including rolling the sleeve from the holdout onto the substrate.

14. The method of claim 10 wherein:
the uncured thermosetting polymer includes an uncured thermosetting epoxide polymer;
the cover assembly further includes a catalyzing agent disposed in the interior cavity;
the uncured thermosetting epoxide polymer and the catalyzing agent are temporarily separated from one another in the interior cavity; and
the method further includes selectively mixing the uncured thermosetting epoxide polymer and the catalyzing agent with one another in the interior cavity to form the hardened resin in the interior cavity.

15. The method of claim 14 including releasing a clamp on the sleeve to permit the uncured thermosetting epoxide polymer and the catalyzing agent to be mixed with one another in the interior cavity.

16. The method of claim 10 wherein the substrate includes a power transmission cable.

17. The method of claim 16 wherein:
the substrate includes a paper insulated lead cable (PILC) including an electrical conductor, an oil impregnated paper insulation layer surrotmding the electrical conductor, and an lead sheath surrounding the oil impregnated paper insulation layer; and
the method includes installing the cover assembly on the PILC such that the cover assembly contains the oil of the oil impregnated paper insulation layer.

18. The method of claim 16 wherein:
the substrate further includes a second power transmission cable and a connector electrically and mechanically connecting the first and second power transmission cables; and
the method includes installing the cover assembly on the first and second power transmission cables such that the cover assembly surrounds the connector.

19. A covered electrical assembly comprising:
an electrical substrate; and
a cover assembly covering the electrical substrate, the cover assembly comprising:
a double-walled, tubular sleeve defining an interior cavity between the walls thereof, the sleeve further defining a passage receiving the substrate; and
an uncured thermosetting polymer disposed in the interior cavity;
wherein, with the sleeve installed on the substrate, the uncured thermosetting polymer can be cured into a hardened resin to form a rigid cover assembly on the substrate, the rigid cover assembly including the sleeve and the hardened resin.

20. The covered electrical assembly of claim 19 wherein:
the substrate includes a paper insulated lead cable (PILC) including an electrical conductor, an oil impregnated paper insulation layer surrounding the electrical conductor, and an lead sheath surrounding the oil impregnated paper insulation layer; and
the cover assembly is mounted on the PILC such that the cover assembly contains the oil of the oil impregnated paper insulation layer.

21. The covered electrical assembly of claim 20 including:
a second electrical conductor and a second oil impregnated paper insulation layer surrounding the second electrical conductor;
a third electrical conductor and a third oil impregnated paper insulation layer surrounding the third electrical conductor;
a second cover assembly mounted on the PILC such that the second cover assembly contains the oil of the second oil impregnated paper insulation layer; and
a third cover assembly mounted on the PILC such that the third cover assembly contains the oil of the third oil impregnated paper insulation layer.
